(19) United States
(12) Patent Application Publication
(10) Pub. No.: US 2021/0101235 A1
(43) Pub. Date: Apr. 8, 2021

(54) Tool, Output and Tool Output Exchange System for Exchanging an Output of a Tool

(71) Applicant: Robert Bosch GmbH, Stuttgart (DE)

(72) Inventor: Joerg Schneider, Fichtenberg (DE)

(21) Appl. No.: 17/026,735

(22) Filed: Sep. 21, 2020

(30) Foreign Application Priority Data
Oct. 7, 2019 (DE) 10 2019 215 328.3

(51) Int. Cl. B23Q 3/12

(52) U.S. Cl. CPC B23Q 3/12; B23B 2260/084

(57) ABSTRACT

A tool has a tool housing with an interface configured for coupling with an interface of an output housing and for coupling with a coupling module. The tool interface is configured for releasably fastening the output interface and the coupling module to the tool, wherein the tool interface is configured, with the output interface, to bring about centering and anti-rotational securement of the output on the tool. The tool interface has coupling elements configured to interact with the coupling module to axially brace the tool and output for securing the output on the tool in order to be able to process at least one workpiece with the processing element.

This application claims priority under 35 U.S.C. § 119 to application no. DE 10 2019 215 328.3, filed on Oct. 7, 2019 in Germany, the disclosure of which is incorporated herein by reference in its entirety.

The present disclosure relates to a tool, to an output and to a tool output exchange system for exchanging an output of a tool. In particular, the disclosure relates to a tool having a universal output interface.

### BACKGROUND

Screwing tools or drilling tools or milling tools are used for processing or treating workpieces in order for example to screw together at least two workpieces to form an object, to unscrew an object, to produce an opening in an object, etc.

Different space conditions are present depending on the processing task. It is thus possible, where appropriate, for the tool to be held only in a predetermined position so that the processing task can be performed. Such tools are therefore equipped with an exchangeable output, such as, for example an angular output or a straight output. It is to be ensured here that, after the exchange, the outputs are mounted firmly and thus securely on the tool.

For this purpose, the outputs could be secured against rotation by form-fitting plug-in contours and axially by means of union nut or axial screw connection.

A problem, however, is that axial screw connections have a relatively large space requirement. This makes the tool unwieldy such that the use range of the tool is limited. In the case of solutions with union nuts, the mounting region of the union nut cannot be used for other purposes, such as for example the attachment of additional components or the through-routing of lines or other items. As a result, the equipment possibility of the tool is limited, and therefore the use range of the tool is thus also restricted.

In addition, there is no possibility of a tool-less exchange of the output with the aforementioned output exchange systems. To release the union nuts, it is necessary to have a special tool, such as, for example a spanner or hook wrench. Here, the tool has to be clamped in to release the union nut in order to support the release torque.

### SUMMARY

It is therefore the object of the present disclosure to provide a tool, an output and a tool output exchange system for exchanging an output of a tool with which the aforementioned problems can be solved. In particular, it is intended for a tool, an output and a tool output exchange system for exchanging an output of a tool to be provided whereby play-free, centric fastening of an output to a motor-operated tool is possible with the possibility of a tool-less quick exchange of the output and in a compact design.

This object is achieved by a tool having the features disclosed below. The tool has a tool housing which has an interface which is configured for coupling with an interface of an output housing and for coupling with a coupling module, wherein the tool interface is configured for releasably fastening the output interface and the coupling module to the tool, wherein the tool interface is configured, with the output interface, to bring about centering and anti-rotational securement of the output on the tool, and to wherein the tool interface has coupling elements which are configured to interact with the coupling module to axially brace the tool and output for securing the output on the tool in order to be able to process at least one workpiece with the processing element.

The tool is configured in such a way that an exchange of the output of the tool is possible without a tool or at least without a special tool. Here, play-free, centric fastening of the output to a motor-operated tool is possible with the possibility of a tool-less quick exchange of the output. The use of union nuts is not required for this purpose. In this way, a very compact design for fastening the output to the tool is realized.

Overall, the output on the tool can be exchanged for another output without effort and thus quickly and comparatively comfortably in order, without a long delay, to be able to execute different processing tasks in succession. The tool is thus very readily adaptable to changing tasks. As a result of this, the tool is suitable for a large range of applications.

In industrial installations in which the tool can be used to process workpieces, the tool output exchange system can contribute to shorter production cycles. It is thereby additionally possible to avoid standstills of an industrial installation which could arise under certain circumstances as a result of an excessively long cycle time for a processing operation with the tool. Moreover, the tool output exchange system can contribute to keeping installation standstills as short as possible.

Advantageous further embodiments of the tool are specified in detail below.

It is conceivable for the tool to additionally have a coupling module for coupling the tool and the output with one another, wherein the diameter of the tool interface is configured in such a way that the coupling module, by spreading open, can be captively latched on the tool interface.

The tool interface can have a spur toothing which can engage in a spur toothing of the output housing in order to couple the output housing and the tool housing. The spur toothing can be a Hirth toothing.

The tool is possibly a screwing tool and/or a drilling tool and/or a milling tool.

In one specific embodiment, the tool is a hand-guided tool. Additionally or alternatively, the tool can be a battery-operated or cable-bound tool.

The aforementioned object is additionally achieved by an output for a tool. The output has an output housing which has an interface which is configured for coupling with an interface of a housing of the tool and for coupling with a coupling module, wherein the output interface is configured for releasably fastening the tool interface and the coupling module to the output, wherein the output interface is configured, with the tool interface, to effect centering and anti-rotational securement of the output on the tool, and wherein the output interface has coupling elements which are configured to interact with the coupling module to axially brace the tool and output for securing the output on the tool in order to be able to process at least one workpiece with the processing element.

The output achieves the same advantages as described above for the tool.

It is conceivable for the output to additionally have a coupling module for coupling the tool and the output with one another, wherein the diameter of the output interface is configured in such a way that the coupling module, by spreading open, can be captively latched on the output interface.

The output interface can have a spur toothing which can engage in a spur toothing of the tool housing in order to couple the output housing and the tool housing. The spur toothing can be a Hirth toothing.

The aforementioned object is additionally achieved by a tool output exchange system for exchanging an output of a tool. The tool output exchange system has a tool with a tool housing, an output with an output housing, which is configured to receive a processing element for processing at least one workpiece, and a coupling module for coupling the tool and the output with one another, wherein the tool housing has an interface and the output housing has an interface which, with the coupling module, form a releasable fastening of the output to the tool in which the interfaces of the housings are configured for the centering and anti-rotational securement of the output on the tool, and the coupling module is configured for axial bracing to secure the output on the tool in order to process at least one workpiece with the processing element.

The tool output exchange system achieves the same advantages as described above for the tool.

The tool interface and the output interface are possibly configured to form at least one form-fitting coupling which couples the tool housing and the output housing in a form-fitting manner.

The tool interface can have oblique flanks and the output interface can have oblique flanks in order to form the form-fitting connection with oblique flanks of the coupling module.

It is also possible for the tool interface to have partial cutouts in the tool housing which are each adapted to the shape of a partial cutout of the coupling module, wherein the output interface has partial cutouts in the output housing which are each adapted to the shape of a partial cutout of the coupling module.

According to one exemplary embodiment, the coupling module is a clamping collar which can be clamped around the tool interface and the output interface by a fastening element with an additional tool.

According to one exemplary embodiment, the coupling module is a clamping collar which has an eccentric lever in order to clamp the clamping collar around the tool interface and the output interface.

At least one above-described tool output exchange system can be part of an industrial installation for treating workpieces, wherein the tool output exchange system is provided for treating at least one workpiece.

Further possible implementations of the disclosure also encompass non-explicitly stated combinations of features or embodiments which have been described above or which will be described below with respect to the exemplary embodiments. In this context, a person skilled in the art will also add individual aspects as improvements or supplements to the respective basic form of the disclosure.

### BRIEF DESCRIPTION OF THE DRAWINGS

The disclosure will be described in more detail below with reference to the appended drawing and on the basis of exemplary embodiments. In the drawing:

FIG. 1 shows a schematic view of an industrial installation with a tool on which a tool output exchange system according to a first exemplary embodiment is mounted;

FIG. 2 shows a three-dimensional view of a coupling module according to the first exemplary embodiment which is provided for mechanically coupling the tool with an output for the tool; and

FIG. 3 shows a three-dimensional view of a coupling module according to a second exemplary embodiment which is provided for mechanically coupling the tool with an output for the tool.

### DETAILED DESCRIPTION

In the figures, identical or functionally identical elements are provided with the same reference signs unless otherwise stated.

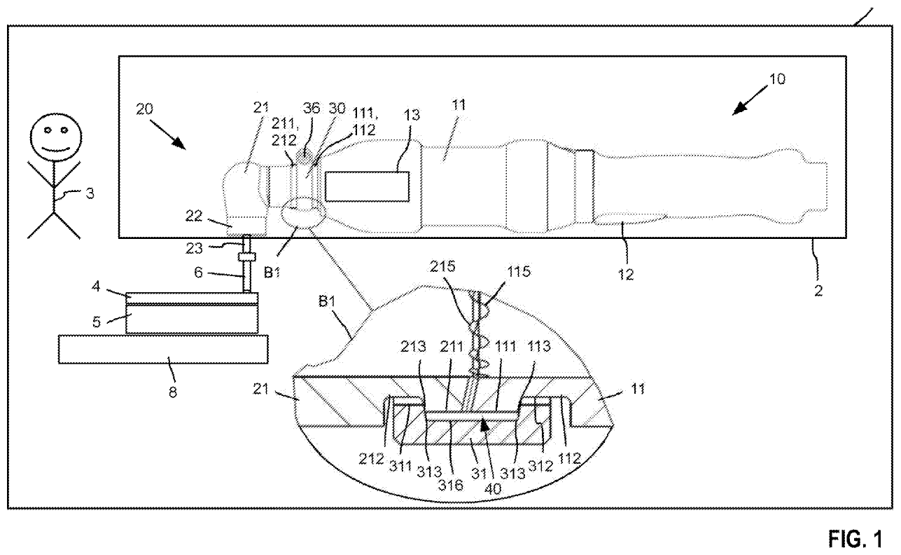

FIG. 1 schematically shows an industrial installation 1 in which a tool output exchange system 2 can be used by a user 3, in particular if at least one workpiece 4, 5 is to be processed. For example, a fastening element 6 can be intended to be fastened into the at least one workpiece 4, 5.

In the example of FIG. 1, the industrial installation 1 has a transport device 8 in order to transport at least one of the workpieces 4, 5. However, the transport device 8 is optional and does not have to be present. Moreover, the transport device 8 can be configured in any desired manner, in particular as a conveyor belt, as a flexible tube, as a separator, as a stacker, as a robot, etc.

The industrial installation 1 is for example a manufacturing plant for objects, such as vehicles, furniture, electrical devices, etc. Additionally or alternatively, the industrial installation 1 can be an installation for the maintenance or disassembly, etc., of objects.

The tool output exchange system 2 has at least one tool 10, at least one output 20 and at least one coupling module 30 for releasably coupling the tool 10 and a presently desired output 20 with one another. As shown in a portion B1 at the bottom in FIG. 1, the coupling module 30 can be spaced apart from the tool 10 and the output 20 by a gap 40 at least in certain portions. This is illustrated more precisely for example at the bottom in FIG. 1 with the enlargement of the elliptical region B1 of the coupling module 30.

The tool 10 in FIG. 1 is a screwing and/or drilling tool. Additionally or alternatively, the tool 10 can be used for milling. Alternatively, the tool 10 can be used for turning, in particular for turning at least one of the workpieces 4, 5 in order to process the at least one of the workpieces 4, 5 with an additional tool.

The tool 10 in FIG. 1 is configured as a mobile tool, in particular as a handheld tool or hand-guided tool which can be manually guided by the user or operator 3. The mobile tool can be battery-operated or mains-operated. Alternatively, the tool 10 is a stationarily installed tool, in particular a screwing spindle or a screwing tool or some other tool, as mentioned above.

The tool 10 has a housing 11 with an interface 111, 112, 115 for coupling the output 20 to the tool 10. The interface 111, 112, 115 is described more precisely below. On the housing 11 there is provided an actuating element 12 for switching on/off the tool 10. Optionally, the actuating element 12 additionally has a control element for controlling the speed of a drive 13 of the tool 10. The drive 13 of the tool 10 is coupled via a shaft to an output shaft of the output 20, even though this is not illustrated more precisely in FIG. 1. As a result, the drive 13 of the tool 10 can drive the output 20 to move. The desired processing of at least one workpiece 4, 5 can thus take place. The drive 13 can be a motor. The tool 10 is thus a motor-operated tool.

The output 20 has a housing 21 on which there is provided an interface 211, 212, 215 for coupling the tool 10 to the output 20. The interface 211, 212, 215 is described more precisely below. In addition, the output 20 has an output receptacle 22 in which a processing element 23 can be received. In the example of FIG. 1, the output receptacle 22 is configured as an exchange chuck in which different processing elements 23 can be received in succession. In the example of FIG. 1, the processing element 23 is a screwing element which can screw a fastening element 6 into at least one of the workpieces 4, 5 or can unscrew it from the at least one of the workpieces 4, 5. Of course, it is possible for the output 20 to be configured to carry out another processing task which is to be formed on the at least one of the workpieces 4, 5. In particular, the output 20 is configured to receive a drilling element or milling element or is configured as a riveting head. Other configurations are of course possible, as already mentioned above for example.

The tool interface 111, 112, 115 and the output interface 211, 212, 215 are configured so as, on the one hand, to couple the tool 10 and the output 20 in the direction of the axis of the drive 13 in a play-free, centric and rotationally secure manner. For this purpose, the tool interface 111, 112, 115 and the output interface 211, 212, 215 have a spur toothing 115, 215. Upon placing the output 20 and tool 10 against one another, these two spur toothings 115, 215 engage in one another. For radial coupling, the coupling module 30 is used.

The spur toothing 115, 215 is in particular a Hirth toothing. The Hirth toothing is distinguished by the fact that, in the joined state, it prevents the output 20 from rotating with respect to the tool 10. In addition, the Hirth toothing ensures centering of the output 20 on the tool 10.

The spur toothing 115, 215 is then to be braced only axially. Therefore, the tool interface 111, 112, 115 and the output interface 211, 212, 215 are configured, on the other hand, to radially fix the tool 10 and the output 20 with the coupling module 30 on the coupling elements 111, 112, 211, 212. For this purpose, the coupling module 30 and the coupling elements 111, 112, 211, 212 have a specific configuration. This is illustrated more precisely for example at the bottom of FIG. 1 with the enlargement of the elliptical region B1 of the coupling module 30.

The housings 11, 21 have cutouts 112, 212 with oblique flanks 113, 213 in order to couple the coupling elements 111, 112, 211, 212 with the coupling module 30. The coupling occurs in particular with oblique inner flanks 313 of the coupling module 30. When clamping the coupling module 30 by means of the fastening element 36, the oblique flanks 113, 213, in coupling engagement with the oblique inner flanks 313 of the coupling module 30, ensure axial prestressing between the output 20 and the tool 10. The cutouts 112, 212 are configured in particular as recesses in the housings 11, 21.

The coupling module 30 of FIG. 1 is configured as a clamping collar which can be arranged around the housings 11, 21 at the coupling elements 111, 112, 211, 212, as shown in FIG. 1. The coupling module 30 has a fastening element 36, in particular a screw, which can clamp the clamping collar onto the coupling elements 111, 112, 211, 212 in order to couple the housings 11, 21.

As illustrated at the bottom of FIG. 1 in the region B1, the coupling module 30 has a U-shaped cross section. The coupling module 30 engages with the legs of the U in a wall 111 of the housing 11 of the tool 10 and in a wall 211 of the housing 21 of the output 20. For this purpose, the housing 11 of the tool 10 has a cutout 112. The housing 21 of the output 20 has a cutout 212. The cutouts 112, 212 project radially into the associated housing 11, 21 with respect to the drive axis of the drive 13.

Stated in more precise terms, one leg of the U of the coupling module 30 engages in the cutout 112 in the wall 111 of the tool housing 11. The other leg of the U of the coupling module 30 engages in the cutout 212 in the wall 211 in the output housing 21. Here, the one leg of the U of the coupling module 30 forms a form fit with the cutout 112 or the wall 111 of the tool housing 11 using the flanks 113, 313. In addition, the other leg of the U of the coupling module 30 forms a form fit with the cutout 212 or the wall 211 of the output housing 21 using the flanks 213, 313. The coupling module 30 thus forms a form-fitting connection with the housings 11, 21.

Consequently, the coupling module 30 is also correspondingly configured in shape so as to couple with the interface 111, 112 of the tool 10 and with the interface 211, 212 of the output 20.

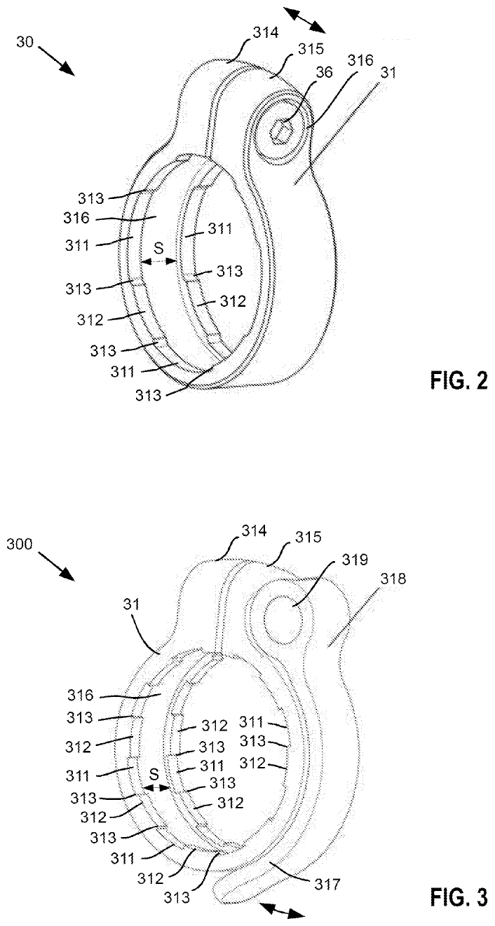

The legs of the U of the coupling module 30 have different lengths along the circumference of the coupling module 30, with the result that cutouts 311 and teeth 312 are formed on the circumference of the coupling module 30. This can be better seen in FIG. 2.

According to FIG. 2, the coupling module 30 is configured as an open ring in its regions in which a releasable coupling is intended to be produced with the coupling elements 111, 112, 211, 212 of the tool housing 11 and output housing 21. The open ring has two ends 314, 315 in which an opening 316 is present. The opening 316 can have a screw thread on the inside. If the fastening element 36 is fastened in the opening, as shown in FIG. 2, the two ends 314, 315 can be pulled against one another, with the result that the ring of the coupling module 30 can be closed, as illustrated by the bidirectional arrow at the top in FIG. 2. FIG. 2 shows the state in which the fastening element 36 fastens the two ends 314, 315 to one another, and the ring is thus closed.

The legs of the U of the coupling module 30 project in the direction of the center of the ring from the inner side 316 of the ring of the coupling module 30. Each of the coupling elements 312 forms a tooth-shaped projection, which are each arranged in an alternating manner with the coupling elements 311, configured as cutouts, of the inner circumference of the coupling module 30. Here, the legs of the U of the coupling module 30 form two tooth rows on the inner side 316 of the ring of the coupling module 30. The tooth rows are spaced apart from one another in the axial direction of the coupling module 30 by a predetermined distance S. As a result, the inner side 316 of the coupling module 30 is arranged over the outer edge of the tool interface 111, 112, 115 and the outer edge of the output interface 211, 212, 215.

Accordingly, the coupling module 30 and the housings 11, 21 are cut-out in segmented fashion. This allows simple mounting of the coupling module 30 on the housings 11, 21. The coupling module 30 can be plugged onto the housings 11, 21 by “tooth on gap” joining, that is to say tooth 312 on cutout 112 and tooth 111 on cutout 311 and also tooth 312 on cutout 212 and tooth 211 on cutout 311. “Tooth on tooth” rotation of the coupling module 30 ensures form-fitting locking of the module 30 and of the housings 11, 21. Clamping the coupling module 30 then generates the necessary axial prestressing for play-free connection of the tool 10 and output 20.

The Hirth toothing of the coupling module 30 ensures centering and anti-rotational securement. The configuration of the coupling module 30 as a clamping collar ensures the required axial prestressing.

Consequently, the interfaces 111, 112, 115, 211, 212, 215 of the housings 11, 21 form, with the coupling module 30, a combination of Hirth toothing and clamping collar for fastening different outputs 20 to the tool 10.

In the present exemplary embodiment, the clamping of the coupling module 30 is carried out with an additional tool to actuate the fastening element 36. The clamping of the coupling module 30 therefore occurs in a tool-associated manner. However, the release of the coupling module 30 and hence of the output 20 from the tool 10 can be carried out without clamping in the tool 10 on, for example, a mounting aid, such as a vice or the like.

The coupling module 30 offers a high degree of flexibility through a free design possibility of the clamping collar. Variants of clamping collars with, for example, an integrated suspension eye and/or attachment possibility for accessories or quick-clamping function are possible.

Another advantage lies in the fact that the coupling module 30 can be very flexibly adapted by the user 3 to the respective user wishes. Here, the coupling module 30 can be configured in a customer-specific manner by means of exchangeable clamping collars.

FIG. 3 shows a coupling module 300 according to a second exemplary embodiment. The coupling module 300 is configured to a wide degree in the same manner as the coupling module of the first exemplary embodiment. Therefore, only the differences between the exemplary embodiments are described below.

By contrast with the preceding exemplary embodiment, the coupling module 300 has an eccentric lever 317. One end 318 of the eccentric lever 317 is mounted on the one end 315 of the coupling module 300 so as to be pivotable about a shaft 319.

FIG. 3 shows the state in which the eccentric lever 317 fastens the two ends 314, 315 to one another, and the ring is thus closed. If, by contrast, the eccentric lever 317 is pivoted away from the ring of the coupling module 300, as illustrated by the bidirectional rotation arrow at the bottom in FIG. 3, the coupling module 300 is opened. In this state, the output 20 can be exchanged.

In the present exemplary embodiment, the clamping of the coupling module 300 can be performed only manually by the user 3. Consequently, the clamping of the coupling module 300 is performed without an additional tool which is to be held in addition to the coupling module 30 of FIG. 2. In other words, the clamping of the coupling module 300 of FIG. 3 occurs toollessly.

According to a third exemplary embodiment, a slideway can be provided in the coupling module 300 of FIG. 3 and can limit the rotary stroke of the coupling module 300 for opening or closing during an exchange of the output 20. For example, the slideway can limit the rotary stroke of the coupling module 300 to the “open” (tooth on gap) position and “closed” (tooth on tooth) position.

According to a fourth exemplary embodiment, the diameters of the housings 11, 21 at the interfaces 111, 112, 115, 211, 212, 215 are configured in such a way that the coupling module 30 or the coupling module 300, by spreading open, can be captively latched on the tool 10. Alternatively, the diameters of the housings 11, 21 at the interfaces 111, 112, 211, 212 can be configured in such a way that the coupling module 30, 300, by spreading open, can be captively latched on the output 20. Here, the coupling module 30, 300 can be fastened with a slight press fit either to the housing 11 or the housing 21.

According to one modification, the coupling module 30 is at least partially configured in one piece with the tool 10. Alternatively, the coupling module 30 is at least partially configured in one piece with the output 20.

The stated configurations according to the fourth exemplary embodiment and its modification are very advantageous since, in addition to the tool 10 and the output 20, a third individual part is not present loose when the output 20 is exchanged.

All of the above-described embodiments of the installation 1, of the tool output exchange system 2, of the tool 10, of the output 20, of the coupling modules 30, 300 and of the method can be used individually or in all possible combinations. In particular, all the features and/or functions of the above-described exemplary embodiments or modifications thereof can be combined in any desired manner. In addition, the following modifications are conceivable in particular.

The parts illustrated in the figures are schematically illustrated and can deviate in the exact configuration from the forms shown in the figures as long as their above-described functions are ensured.

The tool 10 can be configured in particular as an angular head screwing tool or as a flat wrench screwing tool.

In the industrial installation 1 it is possible to use, depending on the application case, any desired materials in any desired combination for the workpieces 4, 5, such as, for example, metal, plastic, leather, glass, paper, etc. It is additionally possible in such an installation for a work method to be carried out, such as transporting the workpieces 4, 5 to the tool 10 in the industrial installation 1 and/or away from the tool 10 and/or stacking of the workpieces 4, 5, etc.

The tool 10 can alternatively be configured as a fixedly installed tool, in particular as a stationary tool, etc. In such a case, a holder for the tool 10 can be present, with the result that the tool 10 cannot be moved in space.

The tool 10 can alternatively be a tool 10 with suspension which can be maneuvered by the operator 3 in order in particular to be able to vary a horizontal position of the tool 10 in space depending on the requirement. The suspension can also make the respective tool 10 vertically adjustable or height-adjustable. Very generally, the position of the tool 10 can be variable in space.

As described above, it is possible for the tool 10 to be configured for manual operation with a battery, in particular a rechargeable battery. Alternatively or additionally, however, a wire-bound connection to a power supply network is possible. In this case, the tool 10 is a cable-bound tool.

1. A tool comprising:
a tool housing which has a tool interface configured for coupling with an output interface of an output housing and for coupling with a coupling module,
wherein the tool interface is configured for releasably fastening the output interface and the coupling module to the tool,
wherein the tool interface is configured, with the output interface, to bring about centering and anti-rotational securement of an output on the tool, and
wherein the tool interface has coupling elements configured to interact with the coupling module to axially brace the tool and the output for securing the output on the tool so as to enable the output to process at least one workpiece with a processing element.

2. The tool according to claim 1, further comprising:
the coupling module, which is configured to couple the tool and the output with one another,
wherein a diameter of the tool interface is configured in such a way that the coupling module, by spreading open, is captively latched on the tool interface.

3. The tool according to claim 1, wherein the tool interface has a first spur toothing configured to engage in a second spur toothing of the output housing to couple the output housing and the tool housing.

4. The tool according to claim 3, wherein the first spur toothing is a Hirth toothing.

5. The tool according to claim 1, wherein:
the tool is a screwing tool and/or a drilling tool and/or a milling tool; and/or
the tool is a hand-guided tool; and/or
the tool is a battery-operated or cable-bound tool.

6. An output for a tool, comprising:
an output housing including an output interface configured to couple with a tool interface of a housing of the tool and to couple with a coupling module,
wherein the output interface is configured to releasably fasten the tool interface and the coupling module to an output,
wherein the output interface is configured, with the tool interface, to effect centering and anti-rotational securement of the output on the tool, and
wherein the output interface has coupling elements which are configured to interact with the coupling module to axially brace the tool and output for securing the output on the tool to enable the tool to process at least one workpiece with a processing element.

7. The output according to claim 6, further comprising:
the coupling module, which is configured to couple the tool and the output with one another,
wherein a diameter of the output interface is configured in such a way that the coupling module, by spreading open, captively latches on the output interface.

8. The output according to claim 6, wherein the output interface has a first spur toothing configured to engage in a second spur toothing of the tool housing in order to couple the output housing and the tool housing.

9. The output according to claim 8, wherein the first spur toothing is a Hirth toothing.

10. A tool output exchange system for exchanging an output of a tool, comprising:
a tool having a tool housing that includes a tool interface;
an output having an output housing which is configured to receive a processing element for processing at least one workpiece, the output housing including an output interface; and
a coupling module configured to couple the tool and the output with one another,
wherein the output interface, with the coupling module, forms a releasable fastening of the output to the tool in which the tool and output interfaces are configured for centering and anti-rotational securement of the output on the tool, and
wherein the coupling module is configured for axial bracing to secure the output on the tool in order to process at least one workpiece with the processing element.

11. The tool output exchange system according to claim 10, wherein the tool interface and the output interface are configured to form at least one form-fitting coupling which couples the tool housing and the output housing in a form-fitting manner.

12. The tool output exchange system according to claim 10, wherein the tool interface has first oblique flanks and the output interface has second oblique flanks in order to form a form-fitting connection with third oblique flanks of the coupling module.

13. The tool output exchange system according to claim 10, wherein:
the tool interface has first partial cutouts in the tool housing, each first partial cutout adapted to a shape of a respective second partial cutout of the coupling module, and
the output interface has third partial cutouts in the output housing, each third partial cutout adapted to a shape of a corresponding second partial cutout of the coupling module.

14. The tool output exchange system according to claim 10, wherein
the coupling module is a clamping collar configured to be clamped around the tool interface and the output interface by a fastening element with an additional tool, or
the coupling module is a clamping collar which has an eccentric lever configured to clamp the clamping collar around the tool interface and the output interface.

15. An industrial installation for treating workpieces, comprising:
at least one tool output exchange system according to claim 10, the at least one tool output exchange system configured for treating at least one workpiece.
